(19) United States
(12) Patent Application Publication
(10) Pub. No.: US 2009/0315390 A1
(43) Pub. Date: Dec. 24, 2009

(54) WHEEL AND LUG NUT SYSTEM

(76) Inventor: Greg Weld, Lee's Summit, MO (US)

Correspondence Address: Greg Weld, 537 Misty Meadow Way, Kansas, MO, 64064, US

(21) Appl. No.: 12/141,697

(22) Filed: Jun. 18, 2008

(51) Int. Cl. B60B 7/14

(52) U.S. Cl. 301/37.376

(57) ABSTRACT

A universal wheel and lug nut system for attaching a wheel to studs extending from a hub of a vehicle is described. The system provides a single wheel that may be used on several different hub arrangements having different bolt circles. The system includes a wheel having a central portion with recesses that form a hole. The hole has an ovular shape to receive the studs. The system includes a lug nut having a washer section and a bushing section with a threaded internal diameter. The washer section has a diameter smaller than a diameter of the recess, and the washer section of the lug nut fits into the recess and the bushing section of the lug nut fits into the hole.

### FIELD OF INVENTION

The present invention relates to a wheel and lug nut system for mounting the wheel to a hub of a vehicle.

### BACKGROUND OF INVENTION

Automotive manufacturers produce vehicles having hubs with different bolt circles. The term “bolt circle” refers to the spacing (from center) of the studs extending from the hub, i.e., the distance that the stud is spaced from the center of the hub. Wheels are usually mounted to the studs extending from the hub using conventional lug nuts. The studs pass through openings of the wheel, and the lug nut threadably tightens on the stud securing the wheel to the hub.

Wheels are an important aesthetic and functional component of a vehicle. Wheels are commonly upgraded and changed to improve vehicular performance or to personalize the vehicle to the owner's tastes. Since many manufacturers use different bolt circles on the hubs of their vehicles, the providers of aftermarket wheels are often forced to keep a large inventory of the same wheel design in different sizes to accommodate the different bolt circles of vehicles manufactured by the various automakers. This increases manufacturing, shipping, and inventory costs. A single wheel that will fit a multiple of different sized hubs on vehicles from different manufacturers if desired.

### SUMMARY OF INVENTION

A wheel and lug nut system for mounting the wheel to a hub of a vehicle is described. A single wheel, as described herein, may be used on several different hub arrangements having different bolt circles, thus providing the wheel with a universal nature. As such, an aftermarket wheel supplier may stock fewer sizes of the wheels described herein and still accommodate consumer demand for wheels that fit a variety of vehicles.

The wheel comprises a plurality of holes that receive studs extending from the hub. The holes comprise an ovular shape such that the wheel may be used on several different types of hubs having stud patterns of different sizes, i.e., the hubs have different bolt circles. The ovular shape of the holes assists in accommodating the different bolt circles.

After the wheel is placed on the studs extending from the hub with the studs inserted into the holes, the lug nut is tightened onto the stud securing the wheel to the hub. The interaction of the structure of the lug nut and the structure of the wheel centers the wheel on the hub, and also assists in accommodating the different bolt circles. Before installation of the wheel to the hub, a tire is usually mounted to the wheel through conventional tire mounting techniques.

### DESCRIPTION OF FIGURES

FIG. 1 is a cross sectional view of the wheel and lug nut system attaching to the hub and the stud.

FIG. 2 is a view of the bushing section of the lug nut

FIG. 3 is a view of the head section of the lug nut.

FIG. 4 is a top view of the wheel.

FIG. 5 is a perspective view of the wheel.

FIG. 6 is a view of the ovular holes.

FIG. 7 is a view of the recess.

FIG. 8 is a close-up view of the recess.

FIGS. 9(a) and 9(b) are views of the bolt circles attaching to the wheel and lug nut system.

FIG. 10 shows a top view of the wheel with six holes.

### DETAILED DESCRIPTION OF INVENTION

A wheel lug nut system 10 that provides a single wheel 200 that fits multiple different sized vehicular hubs from a variety of automobile manufacturers is described herein. The wheel 200 will fit several hubs having different bolt circles. This provides for a universal wheel and lug nut system that reduces manufacturing, shipping and inventory costs. The wheel 200 includes holes 230 having an ovular shape that accommodates the different bolt circles of the hubs from the different manufacturers. The novel structure of a lug nut 100 with its integral washer section 140 operates in conjunction with the ovular shape of the holes 230 to accommodate the different hubs.

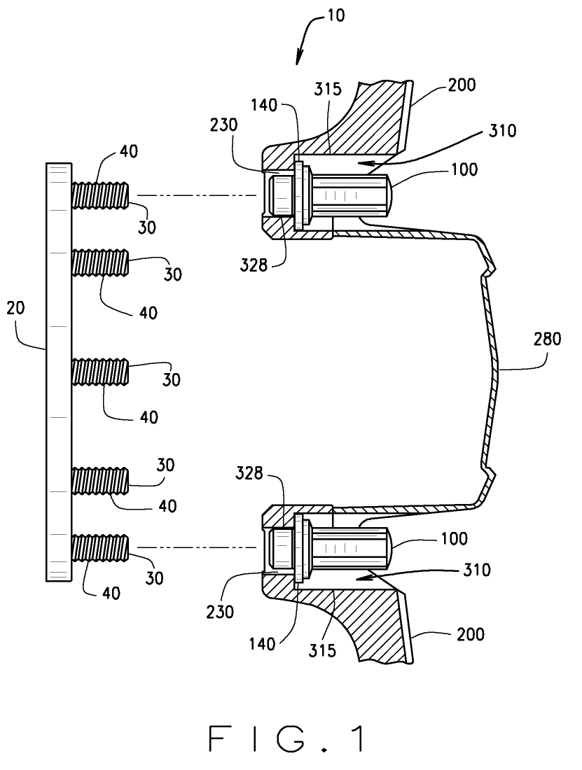

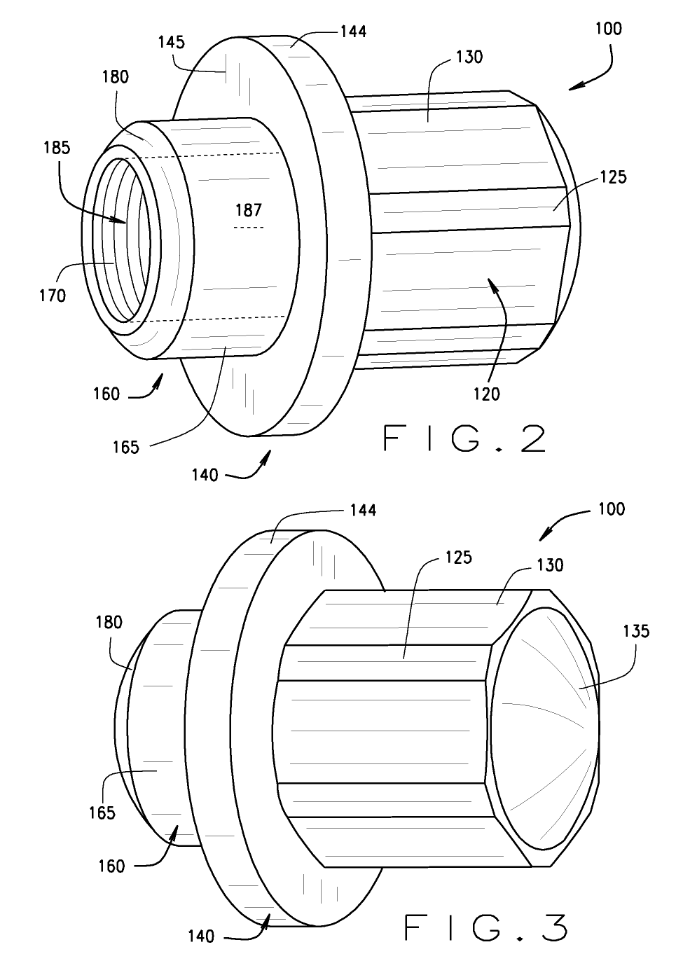

A cross-sectional view of the wheel and lug nut system 10 attaching to a stud 30 extending from a hub 20 is shown in FIG. 1. The wheel and lug nut system 10 comprises the lug nut 100 and the wheel 200. The lug nut 100 is shown in detail in FIGS. 2-3. The lug nut 100 generally comprises three sections, a head section 120, the washer section 140, and a bushing section 160. The lug nut 100 includes these three sections in a one-piece or unitary construction. The washer section 140 is not separable from the lug nut 100 during use or operation, nor is the head section 120 or the bushing section 160 separable from the lug nut 100 during use or operation. The lug nut 100 and it various sections may be forged or milled from a single piece of stock metal alloy.

The bushing section 160 of the lug nut 100 includes a beveled edge 180. The lug nut 100 has a hollow opening 185 into the bushing section 160 and a hollow passage 187 extending into the bushing 160 toward the head section 120 and optionally into the head section 120 in order to threadably receive the stud 30. The bushing section 160 of the lug nut 100 includes a threaded inner diameter 170 starting at the hollow opening 185 that threadably attaches to the stud 30. The lug nut 100 is threaded onto the stud 30 via the threaded inner diameter 170 of the hollow opening 185 and corresponding threads 40 on the stud 30.

The bushing section 160 generally has a narrower diameter than both the washer section 140 and the head section 120. The washer section 140 generally has a larger diameter than both the bushing section 160 and the head section 120. The washer section 140 is adjacent to the bushing section 160. The washer section 140 circumscribes the bushing section 160 and provides a transition to the head section 120. In the embodiment of FIGS. 1-3, the bushing section 160 is integral to the washer section 140, and the washer section 140 is integral to the bushing section 160. The washer section 140 includes a contact surface 145 that urges the wheel 200 to the hub 10 during the tightening of the lug nut 100 to the stud 30.

FIG. 3 shows the head section of the lug nut 100. The head section 120 further comprises surfaces 130 suitable for operative contact with a wrench, socket, air gun or the like for threadably tightening or loosening the lug nut 100 onto or from the stud 30. The head section 120 of the lug nut 100 further includes splines 125 for security purposes. The use of the splines 125 requires that a specialized wrench, socket, air gun, etc. be used in order to remove the lug nut 100, such that theft or vandalism of the wheels 200 is deterred. In this embodiment, the head section 120 has a rounded, solid surface 135 opposite of the hollow opening 185 (shown in FIG. 2).

As shown in FIG. 2, a bushing surface 165 is generally perpendicular to the contact surface 145. The bushing surface 165 is the outer circular surface of the bushing section 120. This arrangement allows the bushing section 160 to pass through the hole 230 of the wheel 200.

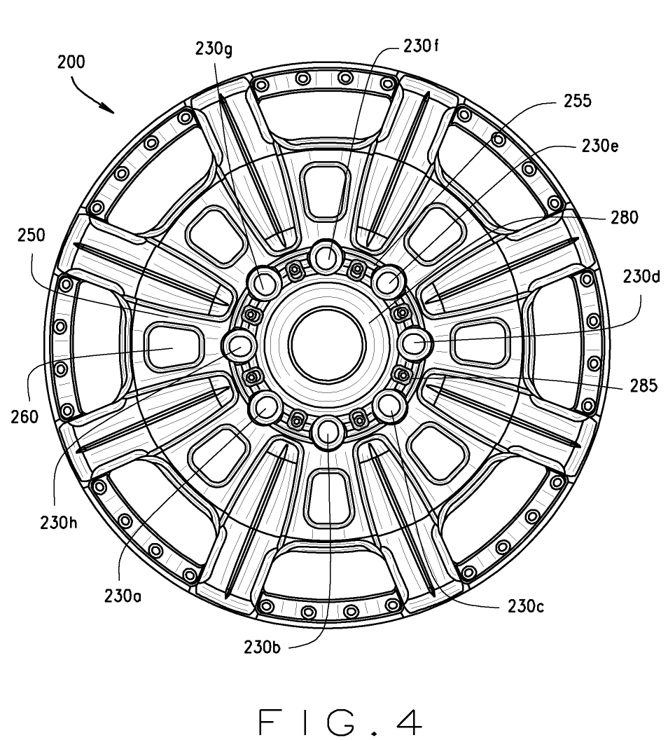

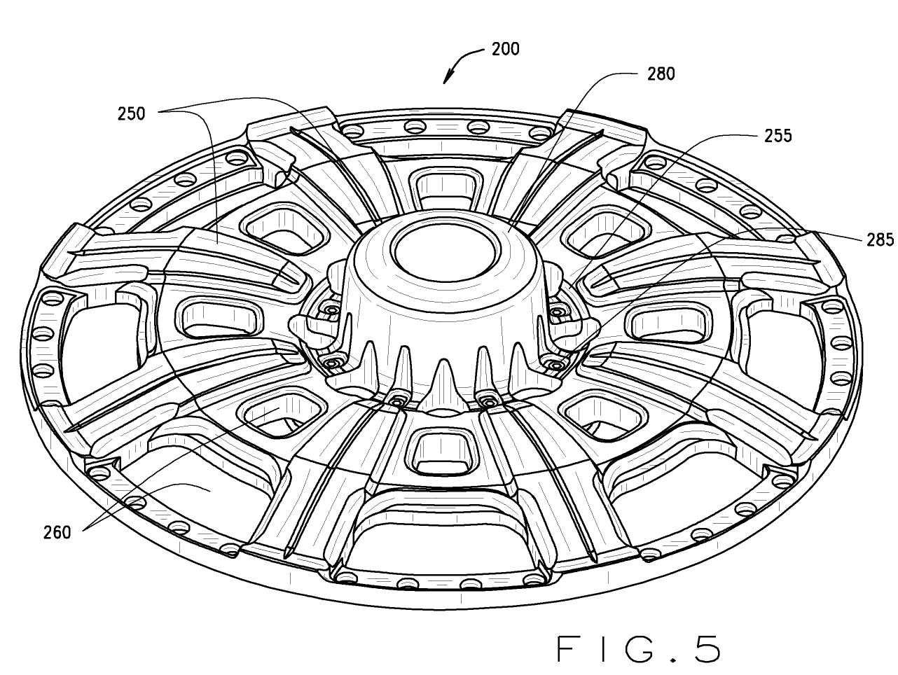

A top view of the wheel 200 is shown in FIG. 4. A perspective view of the wheel 200 is shown in FIG. 5. The wheel 200 includes eight holes 230a, 230b, 230c, 230d, 230e, 230f, 230g, and 230h through which the studs 30 from the hub 20 are inserted. Although the wheel 200 is shown with eight holes 230, in other embodiments, six holes 230a, 230b, 230c, 230d, 230e, 230f or other numbers of holes 230 may be provided. FIG. 10, for example, shows a wheel 201 having six holes 230a, 230b, 230c, 230d, 230e, and 230f. The wheel 201 functions and is designed similar to the wheel 200, except for the use of six holes 230a, 230b, 230c, 230d, 230e, and 230f.

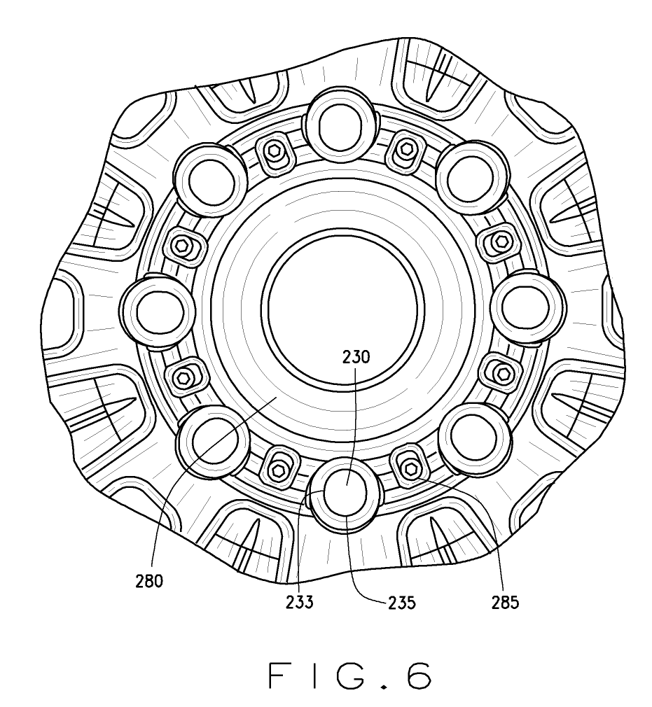

As shown in FIG. 6, the holes 230 comprise an ovular shape. The holes 230 comprise ovular sides 233 and ovular ends 235, wherein the ovular sides 233 are longer than the ovular ends 235 to form the ovular shape. The ovular shape of the holes 230 accommodates various hubs 20 having different bolt circles and contributes to the universal nature of the wheel and lug nut system 10.

With reference to FIGS. 4 and 5, the wheel 200 includes a cap 280 affixed to the wheel 200 via cap fasteners 285. The cap 280 provides a decorative element to the wheel 200 and covers the hub 20. The wheel 200 further includes a plurality of openings 260 circumferentially spaced around the wheel 200. The wheel 200 further includes a plurality of spokes 250 circumferentially radiating from the central portion 255 of the wheel 200. Both the openings 260 and the spokes 250 may be different shapes, sizes, and patterns depending on aesthetic preferences as well as structural integrity for the wheel 200.

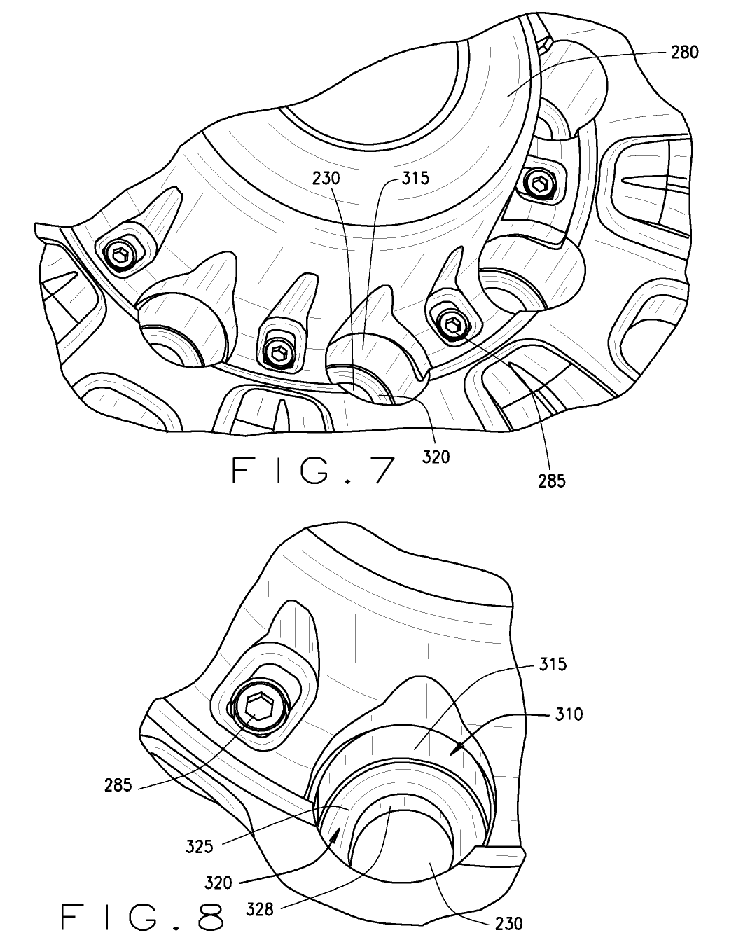

As shown in FIGS. 7 and 8, each hole 230 in the wheel 200 is generally at the bottom of a recess 310. The recess 310 is a depression formed in the central portion 255 of the wheel 200. The recesses 310 are generally circumferentially spaced about a center of the wheel 200. In the embodiment shown, the recess 310 has a generally cylindrical shape with sides formed by the recess walls 315 and a generally flat bottom portion formed by the annular rim 320. The annular rim 320 surrounds the hole 230. The recess 310 has a diameter that is slightly larger than the diameter of the washer section 140 such that the washer section 140 fits completely into the recess 310. An outer perimeter surface 144 of the washer section 140 is aligned in the recess 310 by the recess walls 315.

When the lug nut 100 is threaded on to the stud 30, the bushing section 160 passes through the hole 230, while the washer section 140 and head section 120 are maintained and rotated within the recess 310. The head section 120 of the lug nut 100 has a smaller diameter than the recess 310 and washer section 140, such that a socket, wrench or air gun attachment may fit in between the recess wall 315 and the head section 120 in order grip the head section 120 and its surfaces 130 and rotate the head section 120 within the recess 310 (and likewise rotate the entire lug nut 100).

An annular rim 320 extends from a recess wall 315. The annular rim 320 provides an annular rim surface 325 that receives the contact surface 145 of the washer section 140 as the lug nut 100 is tightened on the stud 30 and against the annular rim surface 325. The contact surface 145 of the washer 140 is tightened against the annular rim surface 325 in tightening the wheel 200 to the hub 10. The annular rim 320 provides an annular rim wall 328. As shown in FIG. 1, the bushing surface 165 is adjacent to the annular rim wall 328 when the bushing section 160 is inserted in to the hole 230. The washer section 140 centers the wheel 200 on the stud 30 and on the hub 20 as the recess walls 315 surround the outer perimeter surface 144 of the washer 140.

The wheels 200 may be hot forged from 6061 Virgin Aerospace Alloy or other suitable alloy and machined using conventional CNC techniques.

The universal nature of the wheels 200 allows a single wheel 200 to accommodate different stud arrangements, i.e., a single wheel 200 may accommodate both a 135 millimeter bolt circle and a 5.50 inch bolt circle or a 170 millimeter bolt circle and a 6.50 inch bolt circle. The universal nature of the wheel 200 reduces inventory, since a single wheel 200 will fit different hubs, i.e., the wheel 200 fits onto a first hub with a first bolt circle and the wheel fits onto a second hub with a second bolt circle, wherein the first bolt circle has a different size than the second bolt circle.

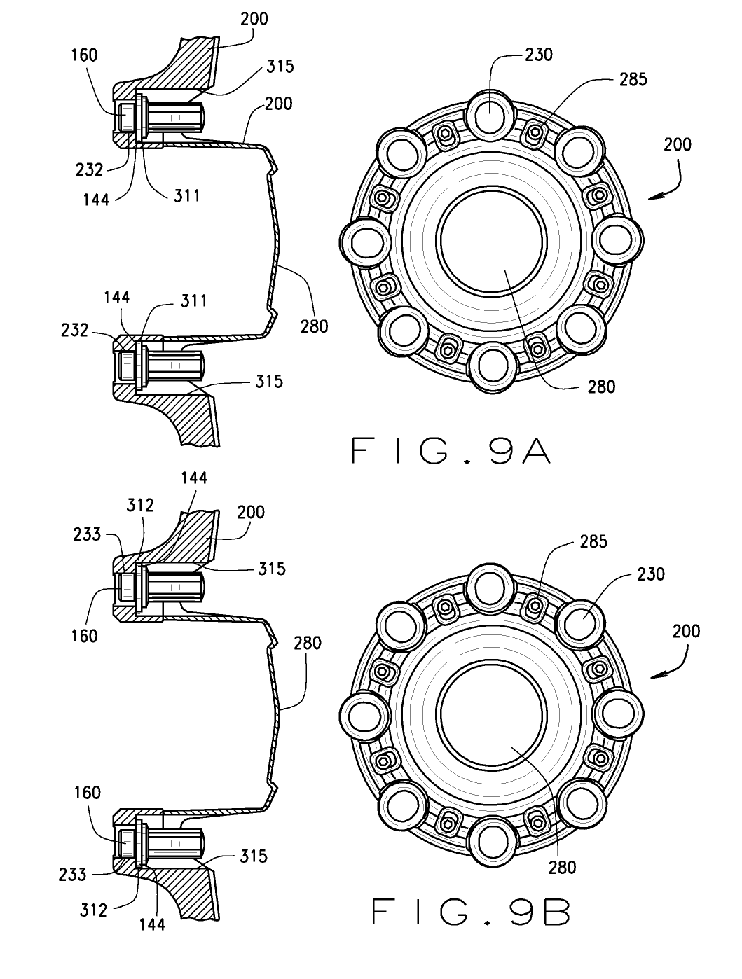

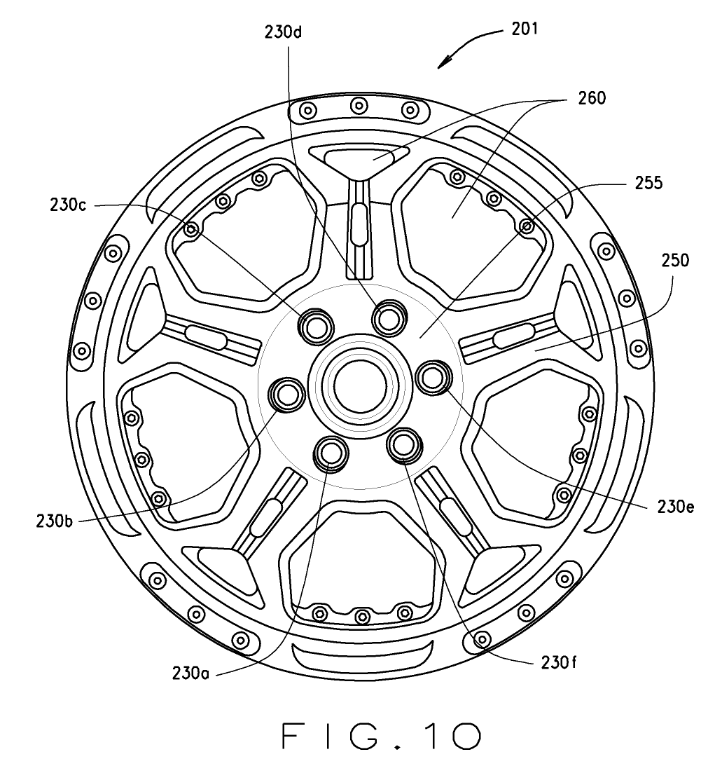

As shown in FIGS. 9(a) and 9(b), the same wheel 200 is fastened to a 6.5 inch bolt circle and a 170 mm bolt circle. The studs 30 are farther from the center of the hub 20 in the 170 mm bolt circle. The ovular shape of the hole 230 accommodates the different sized bolt circles.

In FIG. 9(a), with the smaller bolt circle, the bushing section 160 is pressed against an inner side 232 of the hole 230 and the outer perimeter surface 144 of the washer section 140 is pressed against an inner portion 311 of the recess wall 315. In FIG. 9(b), with the larger bolt circle, the bushing section 160 is pressed against an outer side 233 of the hole 230 and the outer perimeter surface 144 of the washer section 140 is pressed against an outer portion 312 of the recess wall 315.

Those skilled in the art will appreciate that variations from the specific embodiments disclosed above are contemplated by the invention. The invention should not be restricted to the above embodiments, but should be measured by the following claims.

What is claimed:

1. A universal wheel and lug nut system for attaching to studs extending from a hub of a vehicle, comprising:
a lug nut comprising a bushing section having a threaded internal diameter and a washer section;
a wheel comprising a central portion;
the central portion comprising recesses, wherein the recesses form recess walls and the recesses have a hole, wherein the hole has an ovular shape; and
the washer section has a diameter smaller than a diameter of the recess, and the washer section of the lug nut fits into the recess and the bushing section of the lug nut fits into the hole.

2. The wheel and lug nut system according to claim 1, wherein the recess has a generally cylindrical shape formed by the recess walls, wherein the recess has a generally flat bottom portion formed by an annular rim, and the annular rim surrounds the hole.

3. The wheel and lug nut system according to claim 1, wherein the recess is a depression formed in the central portion of the wheel.

4. The wheel and lug nut system according to claim 1, wherein an outer perimeter surface of the washer section is aligned in the recess by the recess walls.

5. The wheel and lug nut system according to claim 1, wherein an annular rim extends from the recess wall and forms an annular rim surface that receives a contact surface of the washer section as the lug nut is tightened on the stud.

6. The wheel and lug nut system according to claim 1, wherein the washer section centers the wheel on the hub as the recess walls of the wheel surround an outer perimeter surface of the washer section.

7. The wheel and lug nut system according to claim 1, wherein the wheel fits onto a first hub with a 135 millimeter bolt circle and a second hub with a 5.50 inch bolt circle, or the wheel fits onto a 170 millimeter bolt circle and a 6.50 inch bolt circle.

8. The wheel and lug nut system according to claim 1, wherein the wheel fits onto a first hub with a first bolt circle and a second hub with a second bolt circle, wherein the first bolt circle has a different size than the second bolt circle.

9. The wheel and lug nut system according to claim 1, wherein the lug nut comprises a head section, the washer section, and the bushing section in a one-piece or unitary construction.

10. The wheel and lug nut system according to claim 1, wherein the washer section is not separable from the lug nut.

11. The wheel and lug nut system according to claim 1, wherein the lug nut has a hollow opening in the bushing section and a hollow passage extending into the bushing toward the head section to threadably receive the stud, the bushing section comprising a threaded inner diameter starting at the hollow opening.

12. The wheel and lug nut system according to claim 9, wherein the bushing section has a narrower diameter than both the washer section and the head section, and the washer section has a larger diameter than both the bushing section and the head section.

13. The wheel and lug nut system according to claim 1, wherein the wheel includes six or eight holes for receiving studs from the hub.

14. The wheel and lug nut system according to claim 1, wherein the recesses are circumferentially spaced about a center of the wheel.

15. The wheel and lug nut system according to claim 1, wherein the wheel fits the hub of a first vehicle from a first automobile manufacturer and the wheel fits another hub of a second vehicle from a second automobile manufacturer.

16. A universal wheel and lug system for attaching to studs extending from a hub of a vehicle, comprising:
a lug nut comprising a bushing section having a threaded internal diameter defining a hollow passage, a washer section integral to the bushing section, and a head section integral to the washer section;
a wheel comprising six or eight holes circumferentially spaced around a center of the wheel, wherein the holes have an ovular shape, and an annular rim surrounds the holes; and
the washer section has a diameter larger than one of the holes;
the bushing section of the lug nut passes though one of the holes; and
the washer section contacts the annular rim as the lug nut is engaged to the stud.

17. A lug nut for attaching to studs extending from a hub of a vehicle, comprising:
a bushing section having an outer circular surface and a threaded internal diameter defining a hollow passage for receiving a stud;
a washer section adjacent to the bushing section, where the washer section has a diameter larger than the diameter of the bushing section;
a head section adjacent to the to the washer section, the head section having diameter smaller than the diameter of the washer section, the head section comprising surfaces for operational contact with a wrench, socket or air gun in order to loosen or tighten the lug nut to the stud; and
the lug nut having the bushing section, the washer section, and the head section in a one-piece or unitary construction.

18. The lug nut for attaching to studs extending from a hub of a vehicle according to claim 17, wherein the bushing section is integral to the washer section, and the washer section is integral to the head section.
